(19) United States
(12) Patent Application Publication
(10) Pub. No.: US 2007/0214069 A1
(43) Pub. Date: Sep. 13, 2007

(54) System for collecting billable information in a group communication system

(76) Inventor: Sacchindrakumar Gopikisan Kalantri, San Diego, CA (US)

Correspondence Address: QUALCOMM INCORPORATED, 5775 MOREHOUSE DR., SAN DIEGO, CA, 92121, US

(21) Appl. No.: 11/363,669

(22) Filed: Feb. 27, 2006

(51) Int. Cl. G07F 19/00

(52) U.S. Cl. 705/34

(57) ABSTRACT

Systems and methods are provided for collecting and managing billable information in a group communication system such as a push-to-talk (PTT) dispatch system. A local node collects the billable event data associated with the group communication and stores it in a flat file database. The billable event data is forwarded from the local node to a centralized node in accordance with a forwarding scheme where it is stored in a more robust relational database.

### BACKGROUND

1. Field of the Invention

The present invention relates to the management and administration of group communications systems. More specifically, the present invention relates to systems and methods for collecting, storing and managing billing information in a group communications system.

2. Background

Group communications systems are used to provide simultaneous communication among multiple users in different locations. Examples of group communications systems include dispatch systems for taxi cab and bus fleets, police forces, fire departments and other emergency personnel. Group communications systems typically allow one user, for example, a taxi cab dispatcher, to simultaneously transmit to the remaining members of the group. The user simultaneously transmitting to group members is sometimes called an originator. Some group communications systems are organized in a less centralized manner, allowing any one member of the group to speak to all other members with different members of the group taking turns transmitting to the other group members.

At present, group communications systems are used by businesses (e.g., fleets of taxis, buses and trucks) and emergency services and governmental authorities (e.g., police and law enforcement agencies, fire departments, military users, forest firefighters or the like). Communication service providers would be more willing to offer group communications services to private users and individual customers if there was a better way of generating revenue. However, the different communication service providers use an assortment of different billing schemes based on various combinations of variables, parameters and billable events. What is needed is a robust, yet flexible, system to collect and manage the various data needed by different service providers for their billing purposes.

### SUMMARY OF THE INVENTION

Aspects of the invention disclosed herein address the above stated needs by providing methods and systems for collecting billable information in a group communications system.

According to various aspects of the invention, apparatus, methods and computer readable media are provided for detecting a group communication among members of a net with multiple subscriber devices and collecting the billable event data associated with the group communication. The billable event data is stored within a local node, for example, in a flat file database. The billable event data is then forwarded from the local node to a centralized node where it is stored in a more robust database, for example, in a relational database within the centralized node.

### BRIEF DESCRIPTION OF THE DRAWINGS

The accompanying drawings, which are incorporated in and constitute part of the specification, illustrate various embodiments of the invention, and, together with the general description, serve to explain the principles of the invention.

FIG. 1 depicts a group communication system;

FIG. 2 depicts a communication manager for implementing various embodiments of the invention; and

FIG. 3 is a flow chart for a method of communicating billable event data from a local log server in the MCU node to the central log server in the CM node.

### DETAILED DESCRIPTION

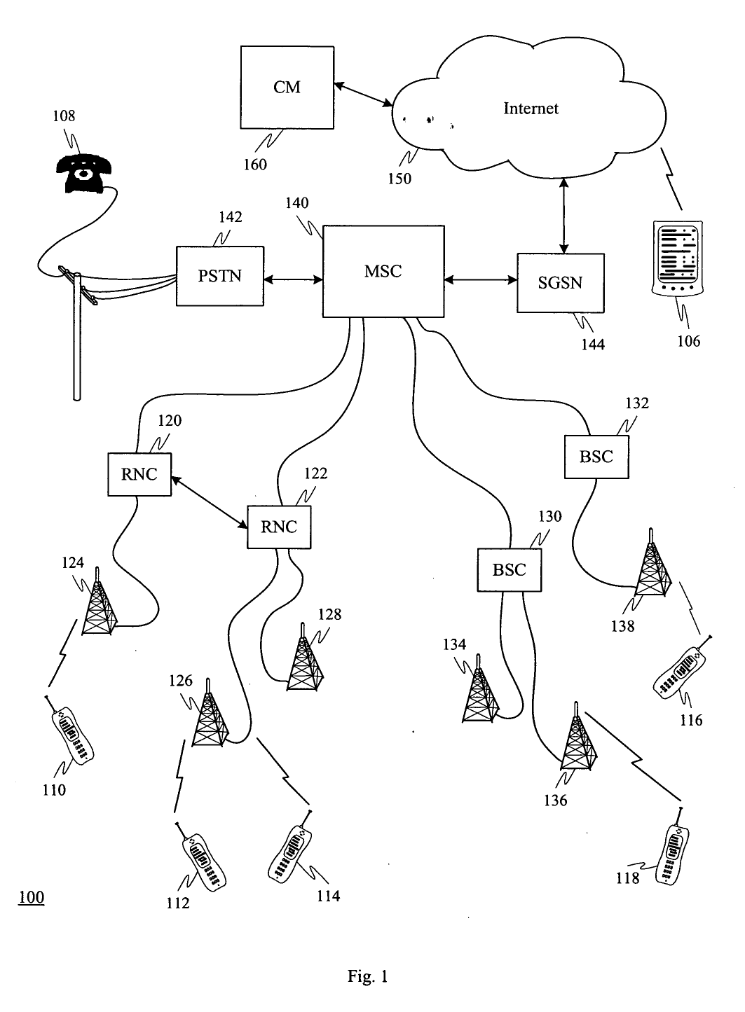

FIG. 1 depicts a group communication system 100 which may be used to implement various embodiments. Group communication systems, such as group communication system 100 of FIG. 1, may be called push-to-talk systems, dispatch systems, net broadcast services (NBS), or point-to-multi-point communication systems. A group communication is transmitted from one subscriber device to a group of two or more other subscriber devices. A “net” is a group of subscriber devices authorized and configured to communicate with each other in a group communication system. For example, the subscriber devices 106-118 may be members of a net, and as such, would be able to participate in group communications. Different members of a net may take turns transmitting and receiving group communications. A subscriber device may belong to more than one net, but generally the device may only be engaged in communications with one net at a particular time. Some embodiments may be implemented such that subscriber devices may be able to have monitor-only privileges in a net. A net may include two or more subscriber devices in some embodiments, three or more subscriber devices in other embodiments, or even dozens or hundreds of subscriber devices in other embodiments. The subscriber devices belong to a net may be referred to as “members” of the net.

The communications from a subscriber device are packaged as Voice over IP (VoIP) frames and transmitted using the net broadcast service (NBS), a VoIP application. The NBS system is described in further detail in U.S. patent application Ser. No. 09/518,985, and U.S. patent application Ser. No. 09/518,776, both filed on Mar. 3, 2000, and each of which are incorporated by reference herein in their respective entireties.

A group communication system may be implemented using an assortment of communication equipment and networks, including First Generation (1G), Second Generation (2G) and Third Generation (3G) equipment. While some legacy 1G network equipment is still in operation, the majority of networks utilize either 2G and/or 3G technology. 1G analog wireless networks were widespread during the early 1990s, but were not readily scalable for the rapid escalation in wireless communications. 2G digital systems provided increased capacity and more services, as compared to 1G networks. Some of the 2G systems currently in operation include Europe's Global System for Mobile Communications (GSM), and the U.S. cellular telephone systems based on Interim Standard 136 (IS-136) and Interim Standard 95 (IS-95). Group communications in accordance with the various embodiments may be carried out in appropriately configured 3G, 2G or 1G systems. Quite often communication systems are implemented primarily as 3G systems but also include legacy equipment compatible with 1G or 2G technology. Group communications systems may be implemented as push-to-talk (PTT) wireless systems using half-duplex communication links to each of the subscriber devices in the net.

Communications among the members of a net may take place within existing communication systems using proven technologies. For example, the exemplary group communication system 100 depicted in FIG. 1 includes 3G equipment (e.g., RNC 120-122 and Node-Bs 124-128) as well as legacy 2G equipment (e.g., BSCs 130-132 and BTS 134-138. Group communication messages may be transmitted in any of several technologies using Internet Protocol (IP). Such communication technologies may include, for example, CDMA (code division multiple access), TDMA (time division multiple access), FDMA (frequency division multiplexed access), OFDMA (orthogonal frequency division multiple access), and systems using a hybrid of coding technologies such as GSM, or other like wireless protocols used in communications or data networks. In some embodiments group communications for a net may be transmitted on a single dedicated broadcast channel from one net member to the other members of the net. The dedicated broadcast channel may be implemented at a given frequency range or communication channel. In other embodiments a collection of different frequencies or channels may be allocated to the net by a controller for group communications.

A number of subscriber devices 106-118 depicted in the figure are capable of engaging in group communications. The group communication system 100 includes a number of node-Bs 124-128 conforming to 3G and each configured to maintain a wireless connection with the subscriber devices 110-114. Each node-B, in turn, is connected to one of the radio network controllers (RNC) 120-122. In accordance with 3G, the RNC 120 and RNC 122 are interconnected via an Iur interface, thus allowing local communication switching between the RNCs. That is, an RNC-RNC communication link may be established for communications between mobile subscribers registered at node-Bs which have connected RNCs, rather than routing the link through the MSC. For example, a communication from subscriber device 110 to subscriber device 112 could be routed from RNC-120 to RNC-122 through the Iur interface between the two RNCs.

It can be difficult for communication providers to gather billing information for group communications using conventional systems since the different communication service providers have different billing schemes based on various combinations of billable events. Service providers require an ability to track NBS service usage in order to bill the subscribers for the provided service. The actual billing scheme may vary from one service provider to another, and service providers may want to implement different billing schemes for different service plans. Hence, a billing scheme specialized for the billing parameters of a particular service provider may not provide sufficient information for the billing scheme of another service provider. The communication manager (CM) system disclosed herein implements a generic scheme that logs all events potentially considered as billable. The CM system provides the service provider the flexibility to pick and choose those events used by the service provider, and subsequently post-process the chosen events into bills. Additionally, in accordance with various embodiments of the invention the service provider may select events to track the system changes and monitor performance. All such events may be referred as business events herein, and are discussed below

The group communication system 100 includes a number of 2G base transceiver stations (BTS) 134-138. Each of the BTS 134-138 is connected to one of the base station controllers BSC 130-132. Unlike the 3G RNCs, the 2G BSCs typically do not have the capability for local BSC-BSC communication switching. The BCSs, the RNCs, and other various elements of the system 100 are typically interconnected via a network of landlines which may include fiber optic cable links and portions of the Internet and/or the PSTN. For example, the MSC 140, RNCs 120-122, node-Bs 124-126, BSCs 130-132 and BTSs 134-138 may be connected using such landlines. In some situations RF links or satellite links may be used to interconnect one or more elements of the system 100.

The RNCs 120-122 and the BSCs 130-132 are each connected to a mobile switching center MSC 140. The MSC 140 is connected to the public services telephone network (PSTN) 142 and to landline PSTN users such as the subscriber device 108 which may be a landline telephones with push-to-talk capability. The MSC 140 is also connected to the Internet 150 via Serving GPRS Service Node (SCSN) 144. Some subscriber devices 106 may be directly connected to the Internet 150, for example, through a wireless access point or other Internet portal. The subscriber devices 106-118 may be implemented as radio handsets or cellular telephones, but may also include many different types of wireless devices such as a wirelessly connected computer, PDA (personal digital assistant), pager, navigation device, music or video content download unit, wireless gaming device, inventory control unit, or other like types of devices communicating wirelessly via the air interface.

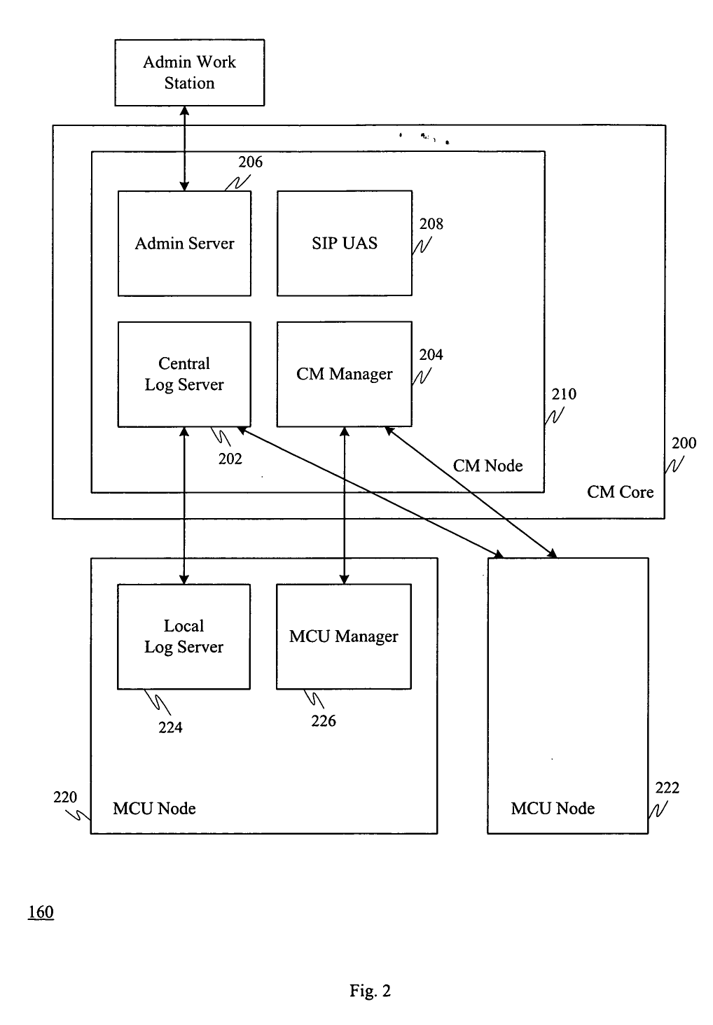

The group communication system 100 includes a central database which may be configured as part of communication manager (CM) system 160 to store information associated with the subscriber members of the nets registered with the system, e.g., user identification and billing information. The CM system 160 may include many distributed devices located within various nodes at different locations. Further details of CM system 160 are further illustrated in FIG. 2.

FIG. 2 depicts a communication manager system CM system 160 configured to implement various embodiments of the invention. The Communications Manager 204 of CM system 160 facilitates interaction with NBS clients (e.g., users with subscriber devices) and inputs from the administrative clients (e.g., service providers). A number of billable events are generated as a result of such interactions. The Communications Manager 204 is configured to capture and record these billable events in persistent databases. The database schema for the event logs can be provided to the service provider. In this way the individual service provider can decide how to use the billable events for their billing purposes in providing group communication services.

An exemplary high level architecture of the Event Logging Service in CM system 160 is illustrated in FIG. 2. As shown, the Event Logging Service comprises a central log server 202 that executes on the CM core 200 and local log servers 224 that execute on each media control unit (MCU) nodes 220-222. The central log server 202 may be located on one node (e.g., a centralized node) while the local log servers are distributed in other nodes throughout the group communication system 100 (e.g., in local nodes that are located closer to end users). The term “local nodes,” as used throughout this disclosure, means the same thing as “originating nodes” and may be used interchangeably with “originating nodes.” In some implementations, however, the centralized node may be co-located with a local node. The components of CM core 200 (e.g., CM Manager 204, Admin Server 206 and session initiation protocol user agent servers 208 (SIP UAS 208)) report events to the central log server 202 running on the CM Core 200. The SIP UAS 208 is sometimes called a redirect server. Each MCU 220, under control of MCU Manager 226, reports its events to the local log server 224 running on that node. The central log server 202 is responsible for maintaining a persistent repository of all the system wide events. Each local log server 224 is responsible for collecting the events specific to its node, and then forwarding the data to the central log server 202. An admin workstation client 240 may be provided to download, process and manipulate data, and to attend to the administration and maintenance of the CM core complex 200.

The CM system 160 may include nodes at points throughout the group communication system 100, such as media control units (e.g., MCUs 220-222). Some of the local nodes may be located proximate, or configured as part of, the MSCs 140, the RNCs 120-122, or other elements of the group communication system 100. The local MCU nodes 220 in CM system 160 may be configured to house local log servers 224 responsible for collecting the events occurring on its node. The nodes of CM system 160 do not necessarily need to be in the same locations as the communication elements of group communication system 100. The CM system 160 nodes may be located in nearly any location where there is Internet access or another readily available means of communication. The local nodes of the CM system 160 collect information pertaining to group communication calls, e.g., billable events. The collected events are stored in a local temporary database, the local log server 224, and forwarded to the central log server 202 within the centralized CM node 210. The central log server 202 may include robust persistent database such as a commercial Database Management System (DBMS). All of the CM system 160 components running on a node, or otherwise associated with that node, report the events to the local log server 224 running on that node. In some embodiments the CM system 160 components reporting events to a log server 224 may include, for example, the group communication subscriber devices registered with a particular MSC. In other embodiments the components may include the subscriber devices belonging to a net (which may possibly be registered with different MSCs).

The local log servers 224 and the central log server 202 may employ the same interface and provide similar services to their clients. The central log server 202 may also be called a central billing log server 202. In some instances a local log server 224 may be executing on the same node as the CM core 200. In some embodiments, the central log server 202 can assume responsibility of the CM Core local log server 224 if the central log server 202 and the other CM components are on the same node and an additional local log server may not be explicitly needed. The central log server 202 may use a more robust relational database (e.g., a relational database) while the local log servers 224 may use native flat-files for event logging. In a flat-file database system, each database is contained in a single table. Relational database systems, on the other hand use multiple tables to store information, and each table can have a different record format.

Another difference between the central log server 202 and the local log servers 224 exist in terms of data forwarding and the flow of billable event data. The local log servers 224 forward the billable event data to central log server 202, but no billable event data passes back from the central log server 202 to the local log servers 224. The central log server 202 acts as a robust repository for event data. The event data eventually makes its way to the different communication service providers who use it in an assortment of different billing schemes based on various combinations of variables, parameters and billable events. The CM system 160 provides a robust, yet flexible, system for collecting and managing the various types of event data needed by different service providers for their billing purposes. However, the event data is not provided to service providers directly from the local nodes. Instead, the data stored in central log server 202 may be accessed by, or provided to, service providers for their billing purposes. The data stored in the local log servers 224 may not be accessed by service providers, until it has been forwarded to the central log server 202.

The local log servers 224 are not required to forward the events immediately to the central log server 202. The local log servers 224 work on a store-and-forward basis, storing the events locally in a flat-file database and then, at its leisure or in accordance with a predetermined data forwarding scheme, forward these events to the central log server 202 for storage in a more sophisticated relational database. The data forwarding scheme may entail a predefined time for forwarding data, for example, after the passage of a certain amount of time since the last data was forwarded, according to a schedule, or at the end of each day during non-peak call time hours. The data forwarding scheme may involve detecting the level of communication activity in the communication system 100 and forwarding the data during times of relative inactivity. The data forwarding scheme may involve measuring the extent to which the capacity of local log server 224 is filled up, and forwarding the data if a certain time of the day (week, month, etc.) is reached or if the local log server 224 reaches a certain percentage of its maximum capacity such as 75% full, or other like percentage. In some embodiments data may be forwarded in response to a synch command. Upon receiving a sync command, the local log servers 224 forward the locally logged events to the central log server 202. The central log server 202 administers the events received from all its clients (e.g., from the individual local log servers 224) to a persistent database (e.g., the DBMS) using a database access server.

The local log server 224 typically employs a simpler and quicker means of logging these events locally, as compared to the system requirements for logging the events directly to the central server 202. While events logged locally at local log server 224 tend to be simpler and quicker, the local log server 224 also tends to be less robust. This allows processing bandwidth to be preserved for purposes such as NBS media signaling, communications of overhead messages, requests, acknowledgements, and the like. The CM system 160 may be configured to have a background thread, running at low priority, dispatch the locally stored events to central log server 202 for storage into the more robust database.

The CM system 160 depicted in FIG. 2 includes a CM node 210 configured as a component of the CM core complex 200 and at least one media control unit depicted as MCU nodes 220-222. MCU nodes 220-222 may also be called local nodes, originating nodes or net modules. The CM system 160 also includes other elements such as one or more administration workstations 240, SIP UAS 208, and domain name service (DNS) servers (not shown) to perform various functions of the CM system 160. For example, the DNS servers control the mapping of DNS hostnames to Internet network addresses. The SIP UAS server 208 responds to user requests for net lists, and also functions in response to SIP invite messages for nets. SIP is an ASCII protocol used to form and control group communications among the members of a net. The SIP UAS server 208 hosts the application responsible for receiving the SIP requests from subscriber devices and responding to the request.

The SIP (session initiation protocol) and NBS (net broadcast service) messages exchanged with the NBS client are not considered events. However, these messages may be logged with the message contents (e.g., in ASCII text format) to facilitate debugging during product development. The logging service may serve as a uniform interface to log such messages locally in a flat file. The users of this service will provide a formatted message while invoking a message log interface. The Message Log Interface may implement filters to selectively toggle on/off the messages to be logged. These filters are different from the filters used to log the events and may be stored as part of the client's configuration.

The CM system 160 may be thought of as comprising two main divisions of elements, a centralized CM node 210, and one or more local MCU nodes 220 which may be distributed throughout the communication system. An initial session for registration of the subscriber device is performed under control of CM node 210. After the initial session, nets of different subscriber devices are operated by one or more local MCU nodes 220-222. The MCU node 220 is configured to communicate information to and from the CM node 210 for operation of the net. One of the MCU nodes 220-222 operates the net once it has been established. Splitting the functions and capabilities between the CM node 210 and the MCU node 220 ensures a versatile yet robust system once a particular net has bee established. In this way the CM node 210 can provide initial connections with other nets with a great deal of flexibility for the type of communication structure in which the net is configured to operate.

The centralized CM node 210 performs the initial registration activities for nets and subscriber devices joining existing nets. In addition, billing information is collected within the central log server 202 of the CM node 210. For example, the CM system 160 may be configured to include a billable event filter to selectively toggle the logging of individual events to the persistent database in the central log server 202. That is, the filter determines which individual events are collected and stored as billable events. This filter is designed to enhance the flexibility of the CM system 160 and can be changed any time or updated as part of a maintenance routine. Changes to the filter parameters are disseminated to all the local log servers 224. The billable event filter may be called other names such as an event log mask, a parameter collection routine, a billable event data specification, or the like. A log server interface may be provided to filter out undesired events reported by its clients (e.g., the local log servers 224) to the central log server 202. An MCD node local log server interface may be provided to filter out undesired events received from the MCU manager 226 before forwarding these to the central log server 202, or before writing the undesired events locally, since once an event is written locally it typically is not filtered again before forwarding to central log server 202.

The CM node 210 also supports and controls the administrative and maintenance functions of the CM system 160. Requests for net lists from subscriber devices are managed within the CM node 210. The CM node 210 responds to session initiation protocol (SIP) invite messages from subscriber devices by assigning the subscriber device to an MCU node 220. Some administrative functions are performed within the CM node 210 by the CM manager 204. For example, the CM manager 204 controls various net administration functions such as creating nets and deleting nets, adding and deleting subscriber devices to existing nets. The CM manager 204 also monitors the status of MCU nodes associated with various nets, and may assign or reassign a net to a particular MCU node. Depending upon where the subscriber devices belonging to a net are located, the CM manager 204 may assign the net to an MCU node that is closest, in the network connectivity sense, to the maximum number of subscribers.

As mentioned above, the central log server 202 is used to centrally collect and store billable events such as call duration, time of call, point-to-point spanned by call, identification information and other like billable events. The central log server 202 collects billable event information from each local log server 224 of the various local MCU nodes 220. The billable events include information from the subscriber devices pertaining to all the group communication parameters used in billing group communications taking place on the different nets active in the communication manager system 160. Events may be categorized into different event types based upon the purpose served by the event. In one embodiment, the events are categorized into the following five event types: 1. Billable Events (or Service Usage Events); 2. System Events; 3. Configuration Management Events; 4. Security Events; and 5. Alerts/Alarms. Each of these five event types may be further organized into subtypes, for example, as described below in conjunction with each event type.

The Event Logging Service executed by central log server 202 and local log servers 224 is responsible for logging the events generated during the lifetime of CM system 160. The logged events serve different purposes to different types of users. For example, the service provider's billing department may be interested only in the business events (e.g., billable events or service usage data) and some configuration management events. Administrative users, on the other hand, may be interested mostly in non-business events (e.g., system events, configuration management events, security events, and alerts/alarms.

Typically, the volume of the business events (e.g., billable events) exceeds the volume of other non-business events. Hence, the logging of business events tends to take more database resources and more time to execute, and may generate larger volumes of data. In some embodiments the event database may be configured to store events only for a predetermined amount of time. The older events may be archived and/or eventually deleted from the event database, e.g., from the central log server 202. As such, the archived events may not be readily available for processing or display purposes. Current events are those events that exist in the database and can be used for processing or displaying. The current events may be defined as events stored in the central log server 202, and may not necessarily include events residing in the local log servers 224 and not yet uploaded to the central log server 202.

Billable Events are events that service providers can select for use in computing its customer billing amounts for usage of the NBS group communication service. The billable events subtypes may include NetEvent, FloorEvent and UserEvent. The billable event subtype NetEvent may include the billable events NetStartedEvent, NetShutdownEvent, and NetDormantEvent. NetStartedEvent is a billable event reported by an MCU whenever a new net is started. NetShutdownEvent is a billable event reported by an MCU whenever the existing net is shutdown. These billable events may be used to track the duration of group communication calls. Other such billable events may be collected for calculating or tracking the time duration of group communication calls for all the members of a net, or for each member of a net. Another billable event, NetDormantEvent is an event reported by an MCLI whenever the Net comes out of dormancy. The billable event subtype FloorEvent may include the billable events PTTGrantEvent and PTTReleaseEvent. PTTGrantEvent is a billable event reported by an MCU when a subscriber device is granted permission to talk. PTTReleaseEvent is a billable event reported by an MCU when the subscriber device releases the floor or the subscriber device is forced to release the floor due to a timeout or a PTT request from a higher priority user. The billable event subtype UserEvent may include the billable events UserjoinedEvent and UserQuitEvent. UserjoinedEvent is a billable event in which the MCU reports new subscriber device successfully joining the net. UserQuitEvent is a billable event in which an MCU reports an existing subscriber device quitting the net or being forced out of the net.

System Events are generally used to monitor the performance of different system units (e.g., the CM system 160 components) such as CM manager 204, SIP UAS server 208, MCU Manager 226, or the like. System Events are generated as a result of system operations such as startup, shutdown, failures and recovery actions. The System Events subtypes may include SystemManagementEvent, DataManagementEvent, ConfigItemCreateEvent, ConfigDeleteEvent and ConfigItemModifyEvent. The system event subtype SystemManagementEvent may include the system events UnitStartupEvent, UnitShutdownEvent, UnitFailureEvent and UnitRecoveredEvent. UnitStartupEvent is a System Event which is registered by the CM Manager 204 after all the other components of the CM System 160 are up and running. The SIP UAS 208 reports the status of the components when it has successfully completed its initialization and is ready to accept SIP INVITES from the NBS clients, e.g., from the subscriber devices. The MCU Manager 226 sends the UnitStartupEvent system event after the MCU log server 224 and all MCUs on the node managed by that MCU manager 226 are up and running. UnitShutdownEvent is a System Event which is reported by the CM Manager 204 after the components of the CM System 160 are successfully shutdown. The SIP UAS 208 reports this when it has successfully completed its shutdown and can no longer process any SIP INVITES from the NBS clients. The MCU Manager 226 sends this event after all the MCUs on the node managed by that MCU Manager 226 are shutdown. UnitFailureEvent is a System Event reported by the CM Manager 204 and the MCU Managers 226 upon detecting that one or more system components managed by them are no longer responding and that these components might have failed. UnitRecoveredEvent is a System Event reported by the CM Manager 204 and the MCU Managers 226 upon successful recovery of the failed entity. The system event subtype DataManagementEvent may include the system events SyncEvent and ArchivalEvent. SyncEvent is a System Event reported by the CM Manager 204 upon explicit invocation of a sync request by the administrative client, e.g., admin workstation 240. ArchivalEvent is a System Event reported by the CM Manager 204 upon the invocation of Archive request by the administrative client.

Configuration Management Events are typically generated whenever the configuration database of CM system 160 is changed. The configuration database holds the static information for such entities as nets, net users, system parameters, and the like. The Configuration Management Events subtypes may include ConfigItemCreateEvent, ConfigItemDeleteEvent and ConfigItemModifyEvent. The Configuration Management Events subtype ConfigItemCreateEvent may include the Configuration Management Events UserCreatedEvent and NetCreatedEvent. UserCreatedEvent is a Configuration Management Event reported by the Admin Server 240 upon successful addition of a new subscriber device to the database. NetCreatedEvent is a Configuration Management Event reported by the Admin Server 240 upon successful addition of a new net to CM database. The Configuration Management Events subtype ConfigItemDeleteEvent may include the Configuration Management Events UserDeletedEvent and NetDeletedEvent. UserDeletedEvent is a Configuration Management Event reported by the Admin Server 240 to the central log server 202 upon successfully deleting an existing subscriber device from the database. NetDeletedEvent is a Configuration Management Event reported by the Admin Server 240 upon successfully deleting an existing net from the database. The Configuration Management Events subtype ConfigItemModifyEvent may include the Configuration Management Events UserModifiedEvent, NetModifiedEvent and SystemModifiedEvent. UserModifiedEvent is a Configuration Management Event reported by the Admin Server 240 to the central log server 202 upon successfully modifying an existing user entry. NetModifiedEvent is a Configuration Management Event reported by the Admin Server 240 to the central log server 202 upon successful modification of an existing Net entry in the CM database. SystemModifiedEvent is a Configuration Management Event reported by the Admin Server 240 to the central log server 202 whenever a configurable parameter of the CM system 160 is modified.

Security Events are events that keep track of the subscriber devices and administrators accessing the database of the CM system 160, for example, through the admin workstation client interface 240. Security Events may include the subtype AccessEvent. The Security Events subtype AccessEvent may include the Security Events UserLogonEvent, UserLogoutEvent and UserLogonFailureEvent. UserLogonEvent is a Security Event reported by the Admin Server 240 to the central log server 202 whenever a user is logged in through the administrative workstation client interface 240. UserLogoutEvent is a Security Event reported by the Admin Server 240 to the central log server 202 whenever a logged-in user logs out (or is logged out) through the administrative workstation client interface 240. UserLogonFailureEvent is a Security Event reported by the Admin Server 240 to the central log server 202 upon detecting that an unauthorized user tried to logon.

Alerts/Alarms may be generated upon discovering a malfunction of the CM system 160, including, for example, a communication outage, a power failure, a software error, detection of a software virus, or other like type of malfunction. The Alerts/Alarms Events subtypes may include ResourceFailureEvent, ResourceUnavailablelEvent and SystemFailure.

The admin workstation client 240 is provided in order to facilitate the downloading and processing of data, and to attend to the administration and maintenance of the CM core complex 200. The admin workstation client 240 may use the services of an admin server 206 to submit online queries to the central log server 206. The central log server 202, in turn, may access the services of a database access server to fetch data from the database. In such embodiments, this process entails an exchanged of data between three different entities. This introduces processing delays before the data is finally handed over to the admin workstation client 240. This arrangement may not always be best suited for queries that generate large volumes of data, as it may take much longer to execute and transport the result data back to the user.

In some embodiments, to provide quicker online queries the queries may be structured in such a way that the resultant response data is relatively small. This may be achieved by defining an event filter to indicate the events that are of interest to the user. The client may record this filter as a part of the configuration information and submit it with all the queries. Additionally, the database access server can filter out those events, or event types, that the user is not authorized to view before executing the query. There are a number of query types that the admin workstation client 240 may use, or may use in combination, to restrict the amount of response data generated by the query. Examples of some queries designed to reduce the response data include: query for all the events but restrict the number of entries reported; query for a specific event; query for events generated during some bounded timeframe; query the events for a specific Net Instance; query the events for a specific Node; and a query the events for a specific User. Since queries performed on system wide events and those related to billing events tend to generate huge amount of data and take longer to execute, in some embodiments such queries are executed as batch submissions or may not be provided as an online option.

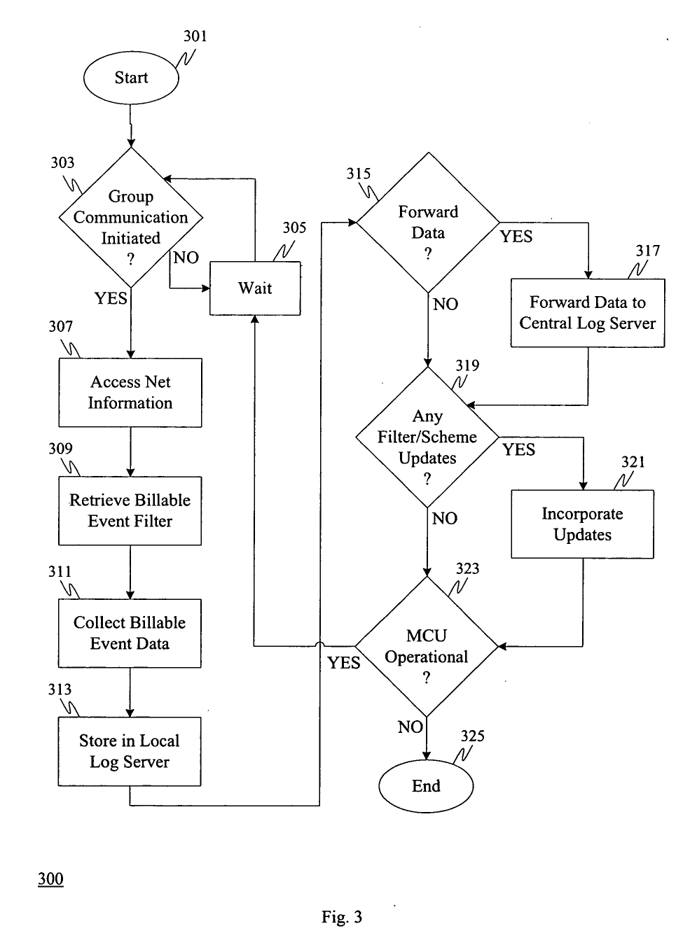

FIG. 3 is a flow chart for a method 300 of communicating billable event data from a local log server 224 in the MCU node 220 to the central log server 202 in the CM node 210. The method begins at 301 and proceeds to 303 where it is determined whether a group communication is being initiated. In some embodiments the centralized CM node 210 sends notification of the group communication call to the local MCU node 220 to which the net making the call is registered. In other embodiments, a message may be sent from the subscriber device initiating the group communication directly to MCU node 220. If the MCU node 220 has not been notified of a group communication the method proceeds along the “NO” branch to 305 to wait for a group communication to be initiated. In 303, once it has been determined that a group communication has been initiated the method proceeds along the “YES” branch to 307.

In 307 the local MCU node 220 accesses information about the net. Such information may include the identity of net members, the service provider, which net members are active and participating in the group communication, which net members are temporarily unavailable but would participate if contact is established, any restrictions or rules pertaining to the billing of net members for the group communication, any restrictions on the amount of charges net member may incur, or other like types of information. Once the applicable net information has been retrieved in 307 the method proceeds to 309 to retrieve the billable event filter for the service provider.

The billable event filter determines which individual events are collected and stored as billable events. This allows a service provider to specify the parameters they are interested, and the billable event filter can be provisioned in the CM node 210 and downloaded to the local MCU node 220 to control which parameters are collected and saved as billable events. Some examples of billable events which may be specified by the filter for collection include NetStartedEvent, NetShutdownEvent, UserjoinedEvent UserQuitEvent (as discussed above), or other like billable events. A billable event filter may be provided for all nets of a particular service provider, or the system may store a billable event filter for each net or group of nets which are subject to the same billing plan. Data may be gathered without using a billable event filter either by specifying a default set of events or by collecting all the available events. Once the billable event filter, if any, is retrieved in 309 the method proceeds to 311.

In 311 data pertaining to the group communication is collected. The collected data is controlled or specified by the billable event filter. The data may be collected by receiving messages at the MCU node 220 from elsewhere in the communication system where timers, control logic and memory registers are located for measuring or accessing the various billable events. Once the appropriate billable events have been collected at the MCU node 220 the method proceeds to 313 for storage of the data in the local log server 224. The local log server 224 is typically designed for logging these events locally in a simpler and quicker manner than would be required if the events were instead stored directly into the central server 202. In some embodiments this is achieved by storing the data in flat-files rather than in a sophisticated relational database. Once the billable events have been logged at the local log server 224 the method proceeds to 315.

The CM system 160 is set up as a store-and-forward system in which billable events are initially logged at the local log server 224 and then the data migrates to the central server 202. In block 315 it is determined whether or not the data is to be forwarded at that time. The billable event data may be forwarded in response to receiving a synch command at the MUC node 220. Upon receiving a sync command, the local log servers 224 forward the locally logged events to the central log server 202. The local log servers 224 may also be configured to forward the collected billable event data in accordance with a data forwarding scheme, e.g., after a certain amount of time has passed or when the data in the local log server 224 reaches a predetermined capacity. If, in block 315, it is determined that the billing event data is to be forwarded the method proceeds from 315 along the “YES” branch to 317 and the data is forwarded to the central log server 202. Once the data has been forwarded, a process which may entail receiving an acknowledgement of receipt back at the local log server 224, the method then proceeds to 319. Back in 315, if it is determined that the billing event data is not to be forwarded at that time the method proceeds from 315 along the “NO” branch to 319.

In 319 it is determined whether there are any updates, modifications or new information to be downloaded from the central CM node 210 to the local node 220. Such downloads may include new iterations of software, updated information regarding one or more of the nets or the subscriber devices, modifications to the billable event filters or data forwarding schemes, or other such changes to the software, routines or data of the MCU node 220. If, in 319, it is determined that there is an update or new information for the MCU node 220, the method proceeds along the “YES” branch from 319 to 321 to receive any such information and implement it in the MCU node 220. Once the updates have been incorporated in 321 the method proceeds to 323. Back in 319, if it is determined that there are no updates or new information for the MCU node 220, the method proceeds along the “NO” branch from 319 to 323.

In the 323 block it is determined whether the MCU 220 node is to remain operational or not. From time to time nodes may be taken off-line for maintenance, or inadvertently due to power outages or the like. If the MCU 220 node is to remain operational the method proceeds in accordance with the “YES” branch from 323 to 305 to wait for another group communication. However, if, in 323, it is determined that the MCU 220 node is to be shut down or taken off-line the method proceeds from 323 along the “NO” branch to 325 where the method ends.

The figures are provided to explain and enable the invention and to illustrate the principles of the invention. Some of the activities for practicing the invention shown in the method block diagrams of the figures may be performed in an order other than that shown in the figures, or described in a manner other than the exemplary descriptions provided herein. For example, the act of accessing net information in block 307 may be performed simultaneously with, or following, block 309 in which the billable filter is retrieved. Also, blocks 303 and 305 of waiting for, and detecting, new group communications my be practiced simultaneously with other activities at all times the MCU node remains operational, and not just in the sequence depicted in FIG. 3. Further, many elements of the various embodiments may be known by terms other than those used herein to describe the various embodiments. For example, the term “subscriber device” used herein could be replaced, in some instances, with the term “user” in describing some of the embodiments, (e.g., the phrase “the subscriber device is granted permission to talk” may, in some instances, be interpreted to mean the same as “the user is granted permission to talk”).

Those of ordinary skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those of ordinary skilled in the art will also appreciate that the various controlling logic, illustrative methodology blocks, modules, circuits, and algorithm routines described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Practitioners of ordinary skill in the art will know to implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, computer or state machine. A processor may also be implemented as a combination of computing devices, e.g., a combination of a DSP and a microprocessor, a plurality of microprocessors, one or more microprocessors in conjunction with a DSP core, or any other such configuration.

The activities of methods, routines or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor in such a manner that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Various modifications to the illustrated and discussed embodiments will be readily apparent to those of ordinary skill in the art, and the principles defined herein may be applied to other embodiments without departing from the spirit or scope of the invention. Thus, the present invention is not intended to be limited to the embodiments shown herein but is to be accorded the widest scope consistent with the principles and novel features disclosed herein. For instance, group communications, and in particular, PTT, are generally thought of as voice communications. However, either voice or data may be transmitted as group communications.

In describing various embodiments of the invention, specific terminology has been used for the purpose of illustration and the sake of clarity. For example, the term “net” has been used to denote a group of communication device users authorized to communicate with each other. However, the invention is not intended to be limited to the specific terminology so selected. It is intended that each specific term includes equivalents known to those of skill in the art as well as all technical equivalents which operate in a similar manner to accomplish a similar purpose. Hence, the description is not intended to limit the invention. The invention is intended to be protected broadly within the scope of the appended claims.

What is claimed is:

1. A local node for collecting and managing billable information in a group communication system, the system comprising:
a media control unit (MCU) manager configured to detect a group communication among members of a net associated with the local node, wherein the MCU manager is further configured to collect billable event data associated with the group communication; and
a local log server configured to store the billable event data within the local node associated with the net upon the group communication ending;
wherein the billable event data from the local node is forwarded to a centralized node.

2. The local node of claim 1, further comprising:
a forwarding scheme saved at the local node;
wherein the billable event data is forwarded to the centralized node in accordance with the forwarding scheme.

3. The local node of claim 1, further comprising:
a filter at the local node configured to define categories of the billable event data to collect.

4. The local node of claim 1, wherein said billable event data is deleted from the local node after the billable event data is forwarded to the centralized node.

5. The local node of claim 1, wherein the local node is one of a plurality of local nodes associated with the centralized node, and said net is one of a plurality of nets configured to engage in group communications, each of said plurality of nets being associated with at least one of the plurality of local nodes.

6. The local node of claim 1, wherein the members of the net comprise at least three members of the net.

7. A system for collecting and managing billable information in a group communication system, the system comprising:
logic configured to detect a group communication among members of a net;
logic configured to collect billable event data associated with the group communication;
logic configured to store the billable event data within a local node associated with the net upon the group communication ending; and
logic configured to forward the billable event data from the local node to a centralized node.

8. The system of claim 7, further comprising:
logic configured to store the billable event data in a relational database within the centralized node;
wherein the billable event data is stored in a flat-file database within the local node.

9. The system of claim 7, wherein the billable event data includes NetStartedEvent specifying when the group communication started among the members of the net, and NetShutdownEvent specifying when the group communication was shut down.

10. The system of claim 7, wherein the billable event data is forwarded to the centralized node in accordance with a forwarding scheme.

11. The system of claim 7, further comprising:
filter logic configured to implement a filter at the local node to define categories of the billable event data to collect at the local node.

12. The system of claim 7, further comprising:
logic configured to delete said billable event data from the local node after the centralized node stores the billable event data.

13. The system of claim 7, wherein the members of the net comprise at least three members of the net.

14. A method of collecting and managing billable information in a group communication system, the method comprising:
detecting a group communication among members of a net;
collecting billable event data associated with the group communication;
storing the billable event data within a local node associated with the net upon the group communication ending; and
forwarding the billable event data from the local node to a centralized node.

15. The method of claim 14, further comprising:
storing the billable event data in a relational database within the centralized node; and
storing the billable event data in a flat-file database within the local node.

16. The method of claim 15, wherein the billable event data includes NetStartedEvent specifying when the group communication started among the members of the net, and NetShutdownEvent specifying when the group communication was shut down.

17. The method of claim 14, further comprising:
using a forwarding scheme at the local node;
wherein the billable event data is forwarded in accordance with the forwarding scheme.

18. The method of claim 14, further comprising:
receiving a synch command at the local node;
wherein the billable event data is forwarded in response to the synch command.

19. The method of claim 14, further comprising:
implementing a filter at the local node to define categories of the billable event data to collect.

20. The method of claim 14, further comprising:
deleting said billable event data from the local node after forwarding the billable event data to the centralized node.

21. The method of claim 14, wherein the local node is one of a plurality of local nodes associated with the centralized node, and said net is one of a plurality of nets configured to engage in group communications, each of said plurality of nets being associated with at least one of the plurality of local nodes.

22. The method of claim 21, wherein messages for the group communication are sent via half-duplex communication links.

23. The method of claim 23, wherein the group communication is transmitted to a first one of the at least three subscriber devices via at least one of a first RNC and a first BSC and the group communication is transmitted to a second one of the at least three members via at least one of a second RNC and a second BSC.

24. The method of claim 14, wherein the members of the net comprise at least three members of the net.
